(19) United States
(12) Patent Application Publication
(10) Pub. No.: US 2019/0066056 A1
(43) Pub. Date: Feb. 28, 2019

(54) SYSTEM AND METHOD FOR AUTOMATED HUMAN RESOURCE MANAGEMENT IN BUSINESS OPERATIONS

(71) Applicant: Atipica, Inc., Redwood, CA (US)

(72) Inventors: Laura I. Gomez, San Mateo, CA (US); Vineet Abraham, San Francisco, CA (US); Prasanna Parasurama, San Mateo, CA (US)

(21) Appl. No.: 16/110,692

(22) Filed: Aug. 23, 2018

Related U.S. Application Data
(60) Provisional application No. 62/549,159, filed on Aug. 23, 2017.

(51) Int. Cl. G06Q 10/10; G06Q 10/06

(52) U.S. Cl. CPC G06Q 10/1053; G06Q 10/06393

(57) ABSTRACT

A system and method for operating an inclusive human resource management tool that includes collecting human resource data from a set of individuals and public source data; extracting demographic profile data from the human resource data for each individual from the set of individuals; compiling the demographic profile data for the set of individuals into demographic rendering as part of the human resource data; analyzing the human resource data, wherein analyzing the human resource data includes creating a bias report; generating a report on the analyzed human resource data.

### CROSS-REFERENCE TO RELATED APPLICATIONS

This Application claims the benefit of U.S. Provisional Application No. 62/549,159, filed on 23-Aug.-2017, which is incorporated in its entirety by this reference.

### TECHNICAL FIELD

This invention relates generally to the field of business intelligence tools, and more specifically to a new and useful system and method for automating human resource management in business operations.

### BACKGROUND

There is an increasing need for companies to address issues of diversity and inclusion. While many companies and businesses have an invested interest in taking steps to improve diversity and inclusion in their work force, there are few tools available to enable such progress. Current approaches during hiring rely on self-reporting of applicants when submitting a job application and self-reporting of companies on their actual demographics. However, this approach will often leave demographics unknown for a large number of applicants that did not self report. As a result many companies do not have a way of monitoring how they measure in terms of diversity and inclusion when hiring, promoting employees from within a company, or how to deal with departing employees. As a result, systemic issues may persist without a mechanism for identifying and acting on such issues. Thus, there is a need in the business intelligence field to create a new and useful system and method for automating human resource management in business operations with an emphasis on monitoring demographic details of a business. This invention provides such a new and useful system and method.

### BRIEF DESCRIPTION OF THE FIGURES

FIG. 1 is a schematic representation of a system of a preferred embodiment;

FIGS. 2A-2D are screenshots of exemplary dashboards;

FIG. 3 is a schematic representation of different data types of a preferred embodiment; and

FIG. 4 is a flowchart representation of a method of a preferred embodiment.

### DESCRIPTION OF THE EMBODIMENTS

The following description of the embodiments of the invention is not intended to limit the invention to these embodiments but rather to enable a person skilled in the art to make and use this invention.

### Overview

A system and method for automating people analytics of a preferred embodiment functions to serve as a business intelligence platform used in recommending improvements to recruiting and other human resource (HR) processes. The system and method can preferably provide granular insights into the diversity and potential biases of a workplace environment. The system and method preferably operates by using internal applicant and/or workforce data, collecting public source data, processing the collected data in combination with predicting a demographic profile of an applicant, and then evaluating the determined demographic profiles of applicants or workforce members across different stages. In some preferred implementations, the system and method can operate independent of optional demographic information that some individuals may provide. The system and method may also aid in human resource type decision-making and evaluation, such as applicant hiring, worker promotions, management promotions, and/or other suitable human resource decisions. Additionally, the system and method may determine demographic bias in human resource type decisions within an organization.

As an example of the capability of the system and method, a resume lacking any explicit statement with regards to demographic information can be used in predicting a demographic profile from the included information in the resume. When such techniques are applied across multiple applicants, a representative and accurate (e.g., greater than 95% accurate) demographic profile can be determined.

In one implementation, a resulting output of the system and method can be a report indicating the balance of different applicant demographics at various stages. This may be presented as a time ordered funnel so that the sequential trend of inclusion can be tracked longitudinally across various business practices like hiring, employee feedback, employee promotions, employee departures, and the like.

As the system and method may report demographic bias in decision making, companies and employers wanting to promote an inclusive environment can use an implementation of the system and method to work towards improved handling of applicants/employees.

Additionally, the system and method may aid companies and employers that want to promote a more inclusive system find diverse candidates that are at least equally as competent as non-diverse candidates.

Through demographic profiling, machine learning, and natural language processing, the system and method may identify more skilled candidates that use different terms that describe their skills and abilities. These candidates may be previously overlooked or under rated, wherein the system and method may properly identify their qualifications.

The system and method is preferably implemented as a “people analytics” business intelligence platform offered as a cloud-hosted platform solution or as a software integration. Multiple companies and businesses can use the platform. Data and demographic profiling conclusions generated from monitoring multiple companies can be leveraged in further improving performance of the system and method. Additionally, higher-level analysis employers can be achieved. For example, regional and/or industry reports could be generated from the participating companies.

As one potential benefit, the system and method can provide a more comprehensive understanding of the demographics of a set of applicants or employees. The system and method preferably generates a demographic profile using standard sources of information such as a resume, a general job application form, an employment form, or other sources. The system and method may not be dependent on self-reporting of applicants.

As another potential benefit, the system and method can be used across many stages of the work lifecycle including hiring, during employment, and employee departure. The system and method leverage and enable demographic detection through basic profile information such that even basic information such as a person's name, phone number, school can provide sufficient demographic profiling detail to enable group demographic analysis.

The system and method may be useful for a wide variety of use cases. Managers and executives of large multi-regional corporations can gain higher resolution and insight into the state of diversity and inclusion in their HR practices across multiple segments of the corporation. Smaller companies, particularly ones undergoing rapid growth, can easily keep track of diversity and inclusion as they attempt to scale their workforce. The system and method can additionally have uses outside of the business world. Universities, government organizations, other forms of programs may similarly leverage the system and method when wanting to promote diversity and inclusion in some application process.

Herein, the description of the system and method may primarily use the exemplary use of the hiring process, but the system and method could similarly be applied to employee “movement” (promotion, demotion, reassignment, stagnation, departure, etc.) within the company or to other areas of interest. Accordingly, the description of a person as an application could similarly be applied to an employee or other type of role of a person.

### System

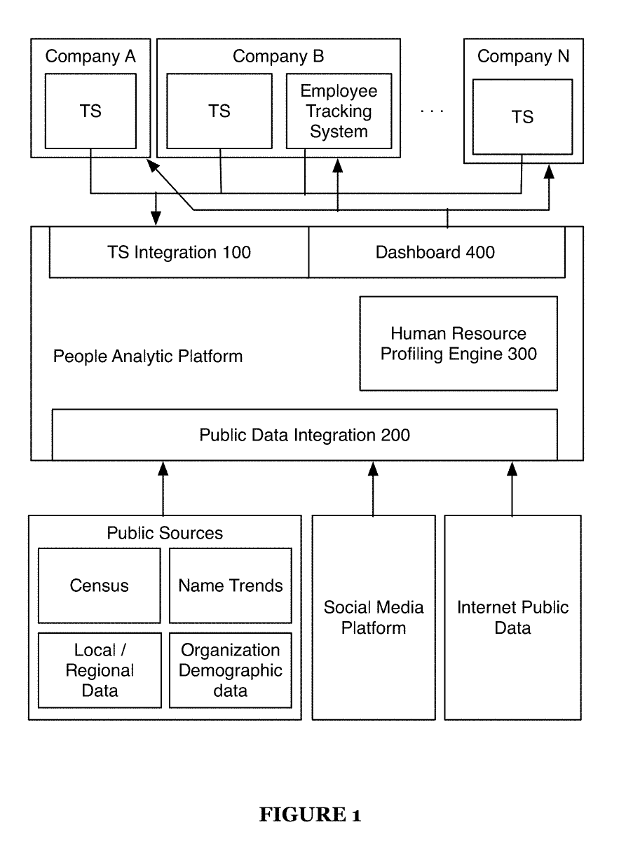

As shown in FIG. 1, a system for human resource management of a preferred embodiment can include a tracking system (TS) integration 100, a public data integration 200, a human resource profiling engine (HRPE) 300, and a dashboard 400. The system functions to collect accessible data and information relating to human resources such as job applicants or employees and generate a demographic profile assessment. The demographic profile assessment may include trends and biases in decision making practices with respect to specific demographics, for example, age, sex, race, religion, veteran status, and disabilities.

The tracking system (TS) integration 100 of a preferred embodiment functions to access direct information of people of interest. The tracking system integration 100 may have access to, or host, human resource data relating to an individual's work “life-cycle”. A tracking system for an organization may track individuals and add, remove, or change the work life-cycle profile. The Work life-cycle profile may include any and/or all data relating to an individual's connection with a specific organization (e.g. club, group company, committee, etc.). For example, for an individual who has just applied for a job at a company the work life-cycle profile for the individual may include the individual's resume and any additional information the individual has provided and/or is publicly accessible (e.g. job form information, cover letters, and/or linked social media profiles, portfolios). For another individual who has worked at the company for several years, the work life-cycle profile may also include any additionally tracked data, such as years of employment, employment position, pay rate, vacation time, reported HR incidents, and/or any other information of interest that has been tracked by the tracking system. Alternatively, a work life-cycle profile for an individual may span beyond the connection of an individual with a single organization and may span multiple organizations. As illustrated by the above examples, an individual can represent a person that is acting as an applicant, employee, participant, and/or any suitable role. For some examples, the tracking system may access all or some of the work life-cycle profile for an individual but present and/or analyze a portion of that data. In one example, a tracking system integration and work life-cycle profile of an individual may span across multiple companies, however the tracking system integration may only access the sections of the work life-cycle profile pertinent to a particular job at a particular company. In the hiring example, the tracking system integration 10o preferably also tracks and incorporates the state of the applicant's process through the application process into the work life-cycle profile.

The tracking system integration 100 can be a third party system used by an organization. In one implementation, the system actively accesses data through an API of the tracking system. API access can enable automatic updating of data. In another implementation, data from the tracking system can be manually imported into the system.

The public data integration 200 functions to collect outside data used as a reference for algorithmic and statistical assessment of the human resource specific data from the tracking system integration 100. Additionally, the public data integration may collect publicly accessible data related to individuals of interest, i.e. individual related data. Multiple public data integrations 200 may be used. Alternatively, general data from the tracking system integration 100 may be used. The public data integration 200 is preferably used to collect large data sets that relate to desired demographics. For example, census data, SSN databases, naming data, school/university/public organization demographic data, zip code data, code data, phone data, local/regional data, and/or other suitable sources of data. Public data can additionally be used across the system platform. For example, public data collected for analyzing job applicants of a first company can also be used in analyzing job applicants of a second company.

The human resource profiling engine (HRPE) 300 of a preferred embodiment functions to transform the work life-cycle profile data, or a portion of the work life-cycle profile, to structured data and then translate the structured data to a demographic profile. The demographic profile may classify or identify properties of individuals by gender, ethnicity, age, socio-economic background, veteran status, disabilities, education, skills, hobbies, and/or other forms of demographic classifications. In one exemplary set of demographics classifications, an applicant may be classified as male or female, as well as White, Asian, Latino, or Black. Demographic profiling may be self reported by applicants, but will preferably be determined by the HRPE 300.

In some instances, inaccuracies of classifying the demographics of a single individual will have small impact to the overall accuracy when considered across a large pool of individuals. Additionally, low confidence demographic profiling for individuals may be weighted accordingly or treated differently to take into account the low confidence of the data. Accordingly, the human resource profiling engine can additionally assist in synthesizing group demographic profile assessments.

Preferably, the human resource profiling engine 300 converts data of an individual to structured data of a population of individuals, and then applies a set of analytic processes that are then used to produce and assess a demographic profile. The configuration to convert individual data to structured data preferably extracts key aspects from the individual data, such as: name, education, clubs/organizations (e.g. fraternity/sorority, professional organizations, cultural organizations, activity organizations, etc.), previous employment, location of employment, residence, phone number, hobbies/interests, and/or other information. The information could be further transformed to other features. For example, a phone number may be converted to a region label based on area code.

The HRPE 300 may additionally include a configuration to search for and process associated data sources pertaining to an individual, i.e. individual related data. The configuration may additionally and/or alternatively search and process referenced material. Data sources pertaining to an individual and/or referenced material may include social media profiles, online profiles, cited papers/publications, minutes from meetings, data repositories, and/or other accessible and/or referenced material. All information found and/or submitted to the HRPE 300 may be used to construct a demographic profile.

The HRPE 300 may include a demographic profile engine. The demographic profile engine functions to apply various forms of processing to the demographic profile data and create encompassing demographic renderings of the sets of demographic profile data. The various forms of processing can be applied across a number of individual demographic profile data attributes, such as gender, ethnicity, age, etc. Other forms of analysis may include natural language processing, heuristic-based analysis, regressions and trend analyses, and/or other suitable forms of processing. The demographic profile engine may perform automated analyses, but may also perform specifically requested analyses. For example, automated analyses may include, but are not limited to, hiring rates for an organization based on sex, distribution of age for management positions within a company, income distributions based on race. Requested analyses can be similar to automated analyses or can be a more (or less) specific breakdown of another analyses. One implementation may be break down of the hiring rates by sex into age groups.

The demographic profile engine can additionally assist in unifying person identity across individual tracking systems. For example, the demographic profile of an applicant managed through a hiring system can then be transferred to a corresponding employee record in an HR management system after the applicant is hired.

The HRPE 300 may additionally have multiple operating modes. The multiple operating modes may aid and/or analyze human resource decisions. For a company, these human resource decisions may include, but are not limited to: employee hiring, firing, promotions, transfers, etc. Preferably the HRPE 300 has: a decision mode, wherein the decision mode aids and/or makes human resource type decisions; and a bias operating mode, wherein the bias operating mode determines and measures demographic bias in human resource decisions. These operating modes may function concurrently, independently, and/or in complement to each other.

The HRPE 300 may preferably have a decision mode. The HRPE 300, through the decision mode, may make and/or aid in human resource decisions. The HRPE 300 may use predetermined decision specific criteria to define an optimal choice for a decision. The predetermined decision specific criteria may be manually entered, determined through machine learning, gathered through external sources, determined through some combination of these methods, or determined from some other combination of method(s). For example, the decision specific criteria for hiring an applicant for a specific job, may be the required skill set for that job. Other decision specific criteria may include years of experience, recommendations, awards, current employment in the same organization or any other relevant information. Wherein a specific skill set is the decision making criteria for hiring, the HRPE 300 may define the optimal candidate as an applicant that has the entire job skill set.

The HRPE 300 may additionally utilize a set of secondary attributes to aid in decision making. Secondary attributes are criteria that do not exactly match the decision specific criteria, but suggest some level of competence in the decision specific criteria. For example, hiring for a Java software engineer, knowledge in the programming language Java would be a specific skill that would be included in the decision specific criteria. Knowledge of other programming languages may still be helpful as a Java software engineer. Thus knowledge of the programming language Python may be considered a secondary attribute for a Java software engineer. Secondary attributes may be determined in the same manner as the decision specific criteria are determined. Secondary attributes may additionally be given a weight, depending on how significant they should be in the decision making process.

As described previously the HRPE 300, through the decision mode, may make and/or aid in human resource decisions. In the hiring case, the HRPE 300 may aid in picking the best candidate(s) from all the applicants. The HRPE 300 may additionally access the work life-cycle of non-applicants and suggest non-applicants for a work position.

The HRPE 300 may additionally have a bias operating mode that through the bias operating mode, the HRPE 300 may determine the existence of demographic bias in some previously made human resource decision. For example, the HRPE may determine a gender bias in a company's promotions by looking through all work life-cycle data for the company and observe a skew favoring equally skilled male candidates as opposed to female candidates for promotions. The HRPE 300 may additionally measure the level of bias, i.e. how skewed the bias is.

The HRPE 300, in the bias operating mode, may additionally take into account an organization's specific demographic, and give suggestions of focus area that may have a significant impact on the level of bias at the organization. In some examples, focus areas may be skills and or skill sets that are referred to differently by different demographics. These skills and/or skill sets may be relatively equivalent. But only one has been chosen for hiring purposes and the other ignored, creating a demographic bias in hiring. For example, the HRPE may determine that an organization that is looking for programming students for internships is preferentially hiring students proficient in one programming language (e.g. Ruby) that is more commonly taught in one socio-economic region as compared to another programming language (e.g. Java) that is typically taught in a different socio-economic region. The HRPE 300 may then determine programming language as a focus area to significantly reduce socio-economic bias in internship selection for this organization. Other focus areas may include, but are not limited to, differences in demographics in how they refer to their own competence, applied knowledge vs. theoretical knowledge, display of confidence, etc.

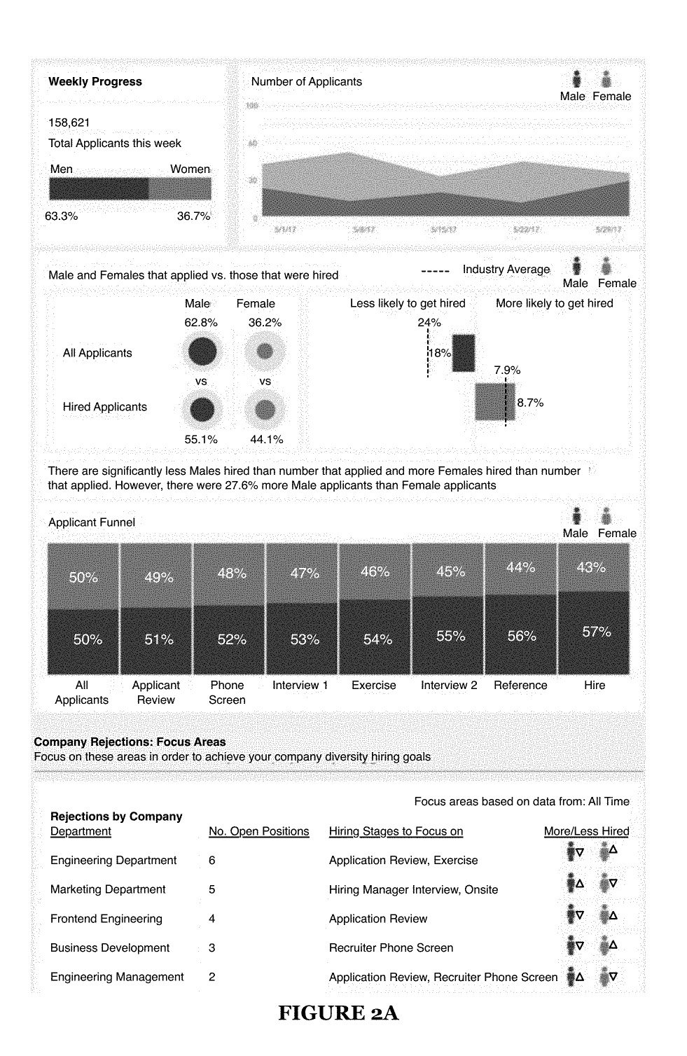

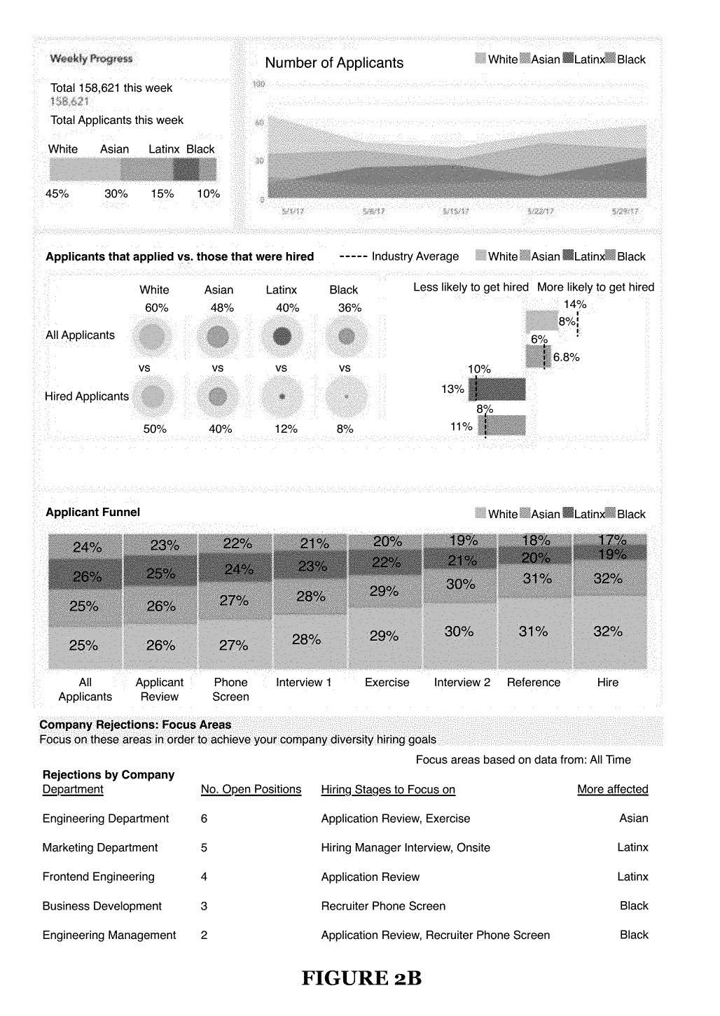

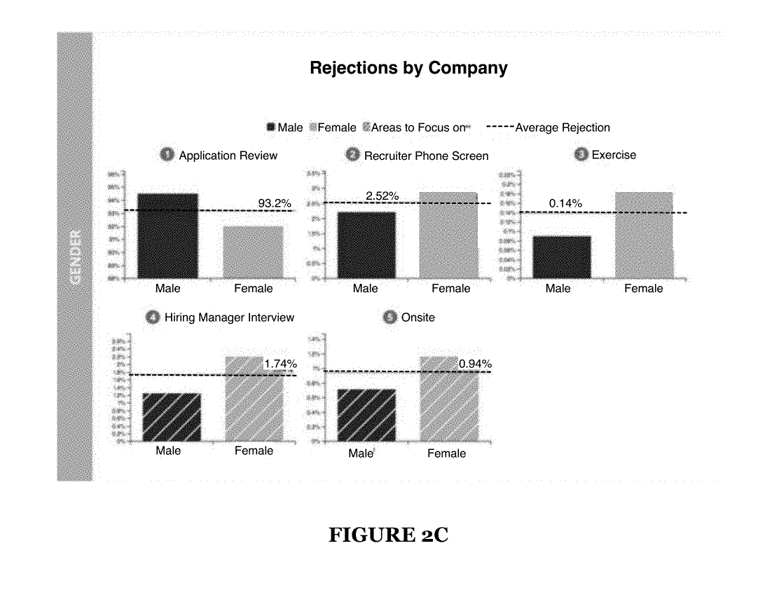

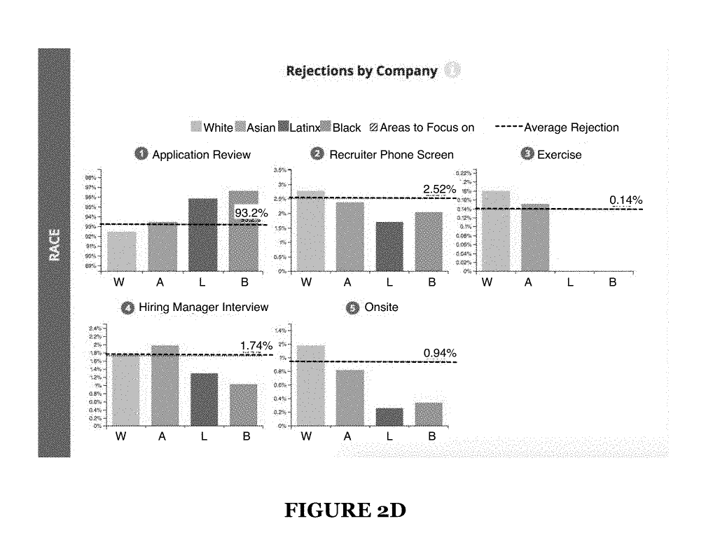

The dashboard 400 of a preferred embodiment functions to present reports, assessments, alerts, and/or other forms of feedback based on output of the HRPE 300. The dashboard 400 is preferably accessible through a web application, a native application, over an API, or through any suitable interface. The demographic profile of the applications is preferably analyzed in combination with data from the tracking system integration 100 and presented as an analysis of an entire applicant pool as shown in exemplary FIGS. 2A-2D. The dashboard 400 may reflect current state of demographics within different population segments. The dashboard 400 may additionally be used to communicate when demographic trends satisfy different conditions. For example, the dashboard 400 may be a medium for communicating when demographic trends may be indicative of an issue. This is preferably the case when different demographic classifications have results with a statistically significant difference. In one preferred implementation, the dashboard 400 can present demographic results for different stages of hiring or promotion track as shown in FIGS. 2A-2D. This can function to show how different stages of a hiring or employee evaluation may be contributing to demographic imbalances.

### Method

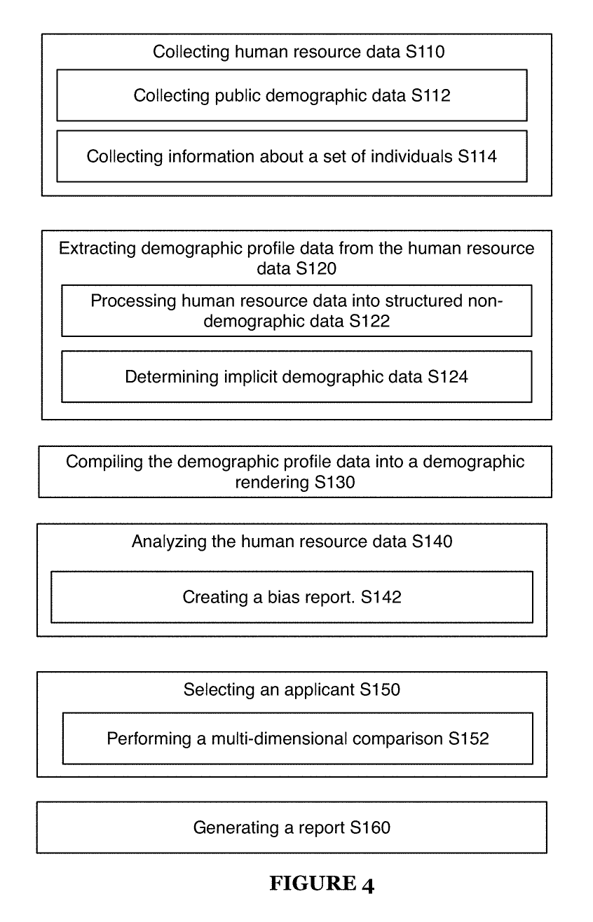

As shown in FIG. 4, a method of a preferred embodiment can include collecting human resource data S110; extracting demographic profile data from the human resource data S120; compiling the demographic profile data into a demographic rendering S130, analyzing the human resource data S140, and generating a report S160. Extracting demographic profile data from the human resource data S120 preferably includes processing the human resource data into structured non-demographic data S122 and determining implicit demographic data S124. Analyzing the human resource data S140 preferably includes creating a bias report S142. In some variations of a preferred embodiment, wherein the method is implemented as a tool to assist in human resource decision-making, the method further includes: selecting an applicant S150, wherein performing a multi-dimensional comparison S152 is preferably included in selecting an applicant.

The method is preferably applied across a set of individuals involved in some vetting process such as a hiring process. Additionally, the method can be incorporated into the human resource decision making and management of an organization, and thus be involved in general monitoring and hiring, firing, promotions, and any other related human resource management issues. The method is preferably implemented by a system substantially similar to the one described above, but any suitable system may alternatively be used. The method is preferably implemented as part of a person analytics platform, wherein different organizations can use the platform to gain insight and direction on demographic inclusiveness, diversity, and treatment.

Block S110, which includes collecting human resource data, functions to collect necessary human resource data. Collecting human resource data preferably includes collecting public demographic data S112 and collecting information about a set of individuals S114. Collecting human resource data S110 may include data that is freely given; data that is publicly searched for, mined, web-scraped; and/or data that is bought from public and private organizations, and or obtained through any other means.

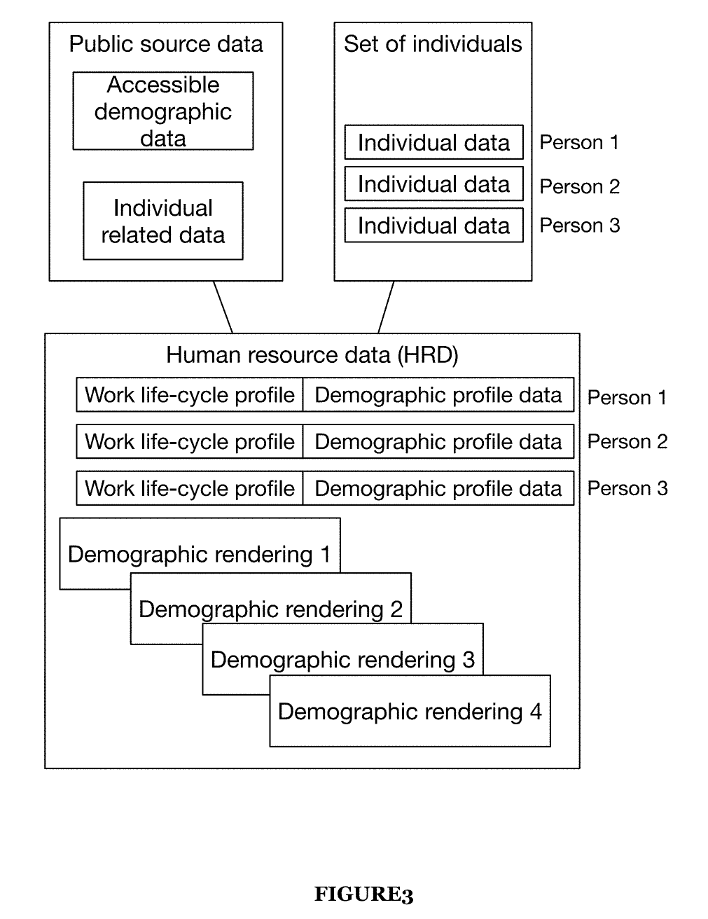

FIG. 3 shows a schematic of the data type and the location of data of a preferred embodiment. Individual data for each individual may be provided by a set of individuals, while public source data may include publicly accessible individual related data and publicly accessible general demographic data. Already collected, and potentially processed, human resource data may include individual specific data and demographic renderings of subsets of the human resource data.

Individual specific data in the human resource data may include the work life-cycle profile of the individual. The work cycle profile may include general collected information, organization related information related to the individual. Examples of work cycle profile data may include, name, hiring date, name of interviewer, job title, wage, promotion date, prior job history and any and-or all other known information. Individual specific data of the human resource data may additionally include demographic profile data. Demographic profile data may include any and/or all demographic data about an individual. Examples of demographic profile data may include, but is not limited to: age, sex, race, veteran status, and disabilities. Although collecting human resource data S110 will preferably collect individual data only during the individual's work life-cycle, the data may be maintained beyond that time. That is, human resource data may contain data for individuals that have no contact with the organization. Thus, data regarding individuals who have applied to the organization but were never accepted are preferably kept and maintained.

Demographic specific renderings of subsets of the human resource data may be demographic collections and organization of the entire population of the human resource data or from subset populations of the human resource data. Examples of demographic renderings for a large company may include, but are not limited to: Gender distribution of all working employees, gender distribution of secretarial staff, age distribution of secretarial staff, gender distribution per occupation, age distribution per occupation, pay distribution per occupation, race distribution of janitorial staff, race distribution of management, race distribution of hired management in the last year, race distribution of management applicants in the last year, etc. As additional individual and demographic information is collected, new demographic renderings may be created and previously created demographic renderings may be updated. Updating demographic renderings will preferably maintain the demographic rendering history such that older version can also be analyzed.

Block S112, which includes collecting public demographic data, is preferably a component of collecting human resource data S110. Collecting public demographic data S112 functions to access publicly available demographic data that is used in assessing the human resource data. The public source data is preferably used in determining how to treat various applicant features that may signal demographic leaning of an applicant. The public source data can include census data, SSN database information, name distribution data, zip code data, local/regional information, business/school/institution/organization data (e.g., demographics of different groups), and/or other information. The public source data may be internalized into the human resource data at one instance. A subset of public source demographic data may additionally or alternatively be periodically updated. Public source data may come from multiple locations. Human resource data for an organization may also become public at one time and be later included in the collected public source data.

Block S114, collecting information about a set of individuals is preferably a component of collecting human resource data S110. Collecting information about a set of individuals S114 may preferably include collecting information provided or associated with the set of individuals. That is, collecting information about the set of individuals S114 preferably includes collecting data from the set of individuals who provide individual data, and collecting individual related data from accessible public source data using methods described previously. The individual data provided by the set of individuals can include resumes, CVs, job applications, forms, cover letters, online profiles, recommendation letters, online portfolios, and/or other information submitted by or in behalf of the individual. Individual related data may include, but is not limited to: social media profiles, shopping profiles, internet footprint, image search and analyses, criminal reports, warrants, newspaper articles, etc. Since the human resource data for an individual is maintained for at least the entire work lifecycle of an individual, collecting human resource information S110 and collecting information about a set of individuals S114 may additionally or alternatively access the work life-cycle profile of the individual.

Compiling the work life-cycle profile of the set of individuals may preferably be a component of collecting human resource data S110. Compiling the work life cycle profile functions to access, create, add, and/or change the work life-cycle profile of the set of individuals. If an individual does not have a work life-cycle profile compiling the work life-cycle profile preferably creates a new work life-cycle profile from the collected individual data, otherwise compiling the work life-cycle profile will add or modify the profile as per the newly collected data. The work life-cycle profile of each individual is the profile storage of all collected analyzed information the individual through entire work “life-cycle” of the individual. That is, data originally collected from previous applications of the method may continue to be maintained and updated at least as long as the individual is connected to the human resource data through the work life-cycle. The compiling of the work life-cycle profile preferably matches demographic profile data to applicants within an automated tracking system or other person tracking system. In one preferred implementation, the demographic profile data can characterize the applicant pools at various stages such as job application submission, candidate selection, phone screening, first phone interview, on-site interview, and hiring review. Another segment of applicants would be applicants that turn down an invitation for an interview and/or decline a job offer. The work life cycle can preferably include multiple stages of an individual's employment while at a company. The movement of employees within a company may be tracked during role changes, promotion, demotion, relocation, departure, firing, and the like through the work life-cycle profile. Additionally, in some variations the method and work life cycle may be implemented more long term than at a single company. Compiling the work life cycle may then additionally include tracking all the mentioned attributes of an individual between companies.

Preferably, compiling the work life cycle profile of an individual further includes analysis in detecting anomalies to the current state, changing trends, or other conditions that may be used to trigger alerts. In one implementation, demographic imbalance may be flagged when there is a statistically significant trend towards biasing towards some set of demographics.

Block S120, which includes extracting demographic profile data from the human resource data, functions to determine a demographic classification for each individual. Extracting demographic profile data S120 may be acquiring demographic data that is explicitly provided by individuals, but may additionally or alternatively include processing human resource data into structured non-demographic data S122, and determining implicit demographic data S124 from the non-demographic data. The demographic profile data may include multiple different types of classifications such as gender, ethnicity, race, age, socioeconomic position, veteran status, disabilities, and/or other classifications. The resulting demographic profile of an individual applicant may be an indication of the most likely demographic classification. The output may alternatively be a set of demographic classifications of an applicant with qualifying metric (e.g., confidence level, probability, etc.). The demographic profile for a set of individuals is preferably a predicted percentage breakdown of different demographic classifications. Non-demographic data may include all other data collected related to an individual, such as: name, location of birth, location of residence, education, employment history.

Block S122, processing the human resource data into structured non-demographic data is preferably a component of extracting demographic profile data from the human resource data S120. Processing the human resource data into structured non-demographic data S122 functions to analyze the human resource data and detect various individual non-demographic data and create or modify the work life-cycle profile of the individual. Exemplary types of non-demographic data can include name, education, list of clubs/organizations (e.g., fraternity/sorority, professional organizations, cultural organizations, activity organizations, etc.), names of past employers, location of employment, location of residence, phone number, and/or other information. These may then be individually processed or used as input features to an algorithm. Processing human resource data into structured non-demographic data S122 of the work life-cycle profile may additionally include detecting referenced material, proactively retrieving the referenced material and processing for demographic profiling. This preferably functions to leverage social media profiles, online resume profiles, online portfolios, cited papers/publications, and/or other referenced material. Specialized analysis processes may be applied for different types of reference material. These may additionally be converted to structured data. Alternatively, the content of such referenced materials may themselves be a form of data input to be processed. Processing the human resource data into structured non-demographic data S122 may additionally enable segmenting of the work life cycle profile such that the demographics can or are organized by the non-demographic data, e.g. by interviewer, group/team, position, department, region, and/or other suitable dimensions.

Block S124, determining implicit demographic data, is preferably a component of extracting demographic data from the human resource data S120. Determining implicit demographic data S124 functions in determining demographic profile data for an individual who has not explicitly provided the desired demographic information. In some preferred variations determining implicit demographic data S124 is performed regardless of whether or not the demographic data is explicitly provided. This secondary method in determining demographic profile data may help ensure the accuracy of the data. General demographic trends and correlations in conjunction with non-demographic data may be used to determine demographic profile data. Machine learning and multi-variable analyses may be additionally utilized to determine and then implement newly observed trends. In one exemplary implementation, determining implicit demographic data S124, a NLP model can be used in classifying student organizations by gender and/or ethnicity associations to account for the wide variety of organization names. In another example, NLP analysis of writing style in job application questionnaires may be used.

Determining implicit demographic data S124, may preferably comprise of a combination of processes including: applying data analysis of the human resource data, and actively retrieving and processing human resource data. This combination of techniques may be to address a potential challenge where no single indication may provide a definitive result for all individuals within an organization. For example, predicting gender from the name may not work for names that are commonly used as male or female names, and predicting ethnicity from detecting membership or participation in an ethnically-focused organization may also not provide a fully accurate assessment for all applicants.

Applying data analysis of the human resource data is preferably a component of determining implicit demographic data S124. Applying data analysis of the human resource data functions to use data in analyzing aspects of the work life-cycle profile of the set of individuals. Applying data analysis of the human resource data is based in part on previously determined and/or obtained demographic data. The demographic data is preferably used in mapping various non-demographic data of an individual, such as location, group associations (e.g., universities, student activities, past employment, etc.), and/or other aspects for use in predicting demographic leanings of individuals within an organization. For example, the demographic prediction of an individual may be heavily influenced by their place of residence and the school they attended based. Similarly, the name of an applicant may be a demographic predictor (e.g. gender).

Actively retrieving and processing human resource associated data is preferably a component of determining implicit demographic data S124. Actively retrieving and processing human resource associated data functions to fetch data to further analyze. This additional data may then be included in the work life-cycle profile of an individual and be used to aid determining demographic profile data. This may include reactively retrieving associated references that are cited and/or newly determined. Actively retrieving and processing human resource associated data may also include proactively searching and identifying outside material corresponding to an individual (e.g. information that did not exist at a previous time). In one particular implementation, actively retrieving and processing human resource associated data may include collecting suspected pictures of an individual and then applying computer “vision” to form a classification. For example, the name of a job applicant (possibly coupled with other labels such as a school or past employers) may be used to generate an image query. Results of the query can then be processed. As one note, the suspected pictures are preferably of the individual of interest, but pictures of other people could also in some cases provide a similar understanding of the demographic tendencies of people with that name.

Block S130, which includes compiling the demographic profile data into a demographic rendering functions in gathering demographic profile data and creating a new demographic rendering and/or updating a previously created demographic rendering. Compiling the demographic profile data into a demographic rendering S130 may be standardized process wherein, specific demographic renderings are updated and/or created each time the method is called, but may additionally or alternatively create a specifically requested demographic rendering.

Updating a previously created demographic rendering is preferably a component of compiling the demographic profile data into a demographic rendering S130. Updating a previously created demographic rendering will preferably maintain the versions/history of the demographic rendering such that previous versions of the demographic rendering may also be analyzed, but alternatively the updating a previously created demographic rendering may erase prior versions.

Block S140, which includes analyzing the human resource data, functions to apply heuristics, machine learning techniques, natural language processing, statistical analyses, regressions, and/or other forms of analysis to the demographic renderings and to the demographic profile data of individuals. Analyzing the human resource data S140 may determine demographic trends in an organization, decision making preferences towards specific demographic biases, changes in demographic preferences. Analyzing the human resource data S140, may show other demographic trends and metrics as desired. In addition, analyzing the human resource data S140 may include creating a bias report S142. In one example for an airline company, analyzing the human resource data S140 may determine a preference of hiring pilots that have previously served in the air force, and that the rate of air force servicemen hired as pilots is increasing at the airline company. Simultaneously, analyzing the human resource data S140 may determine a preference of hiring women as cabin crew, but that the percentage of hiring women as cabin crew is decreasing.

Block S142, creating a bias report is preferably a component of analyzing the human resource data S140. Creating a bias report S142 functions to first determine whether a human resource decision (e.g. hiring and firing) is made with or without any demographic biases, and to then measure the level of that demographic bias. A human resource decision is any type of decision related to organization implemented changes to any work life-cycle. The human resource decision may preferably be hiring related (e.g. hiring an applicant, inviting an applicant for an interview, making an offer), but may alternatively be any type of human resource decision in the work life-cycle. Examples of human resource decisions may include, but are not limited to: hiring, firing, promotion, demotion, transfer, change in pay rate, awards, or distinction. For example, creating a bias report S132 for hiring from an applicant pool of a set of individuals, may entail determining bias by comparing the hiring rate of equally skilled applicants of distinct demographics. In this example, if the number of applicants from each demographic is equal then the hiring would be unbiased if the number hired from each demographic was also equal. Determining bias is preferably done with respect to the skill level of individuals, but other metrics showing competence may alternatively be implemented. Examples of possible competence metrics may include, but are not limited to: amount of experience, education, recommendation letters, or company reviews.

Creating a bias report S142 may further include measuring the level of bias. Measuring bias may be implemented by first determining an unbiased rate for a human resource decision. The bias may then be measured by measuring the difference between the unbiased decision rate versus the actual decision rate. Returning to the airline company example, it may be determined that air force veterans are significantly more skilled pilots than non-air force pilots. Thus, although there is a preference to hire air force veterans and this trend is increasing, the bias report may show little bias in the hiring of pilots, and that the bias for the hiring of pilots is decreasing. With respect to cabin crew, it may be determined that men and women are equally skilled flight attendants. The bias report may then show a definite biased preference for hiring women, and that the bias is decreasing since the ratio of women being hired is decreasing.

Creating a bias report S142 may additionally include suggestions to reduce bias in decision making. Bias-reduction suggestions will generally be organization specific to help address potential areas of improvement. For example, suggestions for hiring decisions, may include specific hiring recommendations; such as increasing the priority for a specific skill level over some preferred demographic, or even suggesting hiring a specific demographic.

Block S150, which includes selecting an applicant, may further be a component of the method for a preferred embodiment wherein a human resource decision is made. Selecting an applicant S150 functions as making a human resource decision. Selecting an applicant S150, may additionally include performing a multi-dimensional comparison S152 between each applicant and the human resource decision to determine a best applicant.

In one variation, selecting an applicant S150 entails selecting an applicant from the set of individuals who are explicitly eligible for the human resource decision. For the example where the method is used in conjunction with hiring someone, selecting an applicant S150, preferably selects an applicant from the set of individuals that applied for the jobs. In another preferred variation, selecting an applicant S150 selects an applicant from the set of all individuals that have their work life-cycle profile stored in the human resource data. Alternatively, some combination or subset of all individuals within the human resource data may be selected.

Block S152, performing a multi-dimensional comparison, is preferably a component of selecting an applicant S150. Performing a multi-dimensional comparison S152 functions to determine the best applicant, or best applicants, for the human resource decision. Performing a multi-dimensional comparison S152 compares the skills, traits, and demographics of each candidate to the skills, traits, and demographics preferred for the human resource decision. Preferably, the best applicant is the candidate with the best matching comparison. In one example, for hiring a front-end Python software engineer; the preferred skills, traits, and demographics may be skills in Python, experience building a user interface, and design experience. In some preferred embodiments, the multi-dimensional comparison may include mapping the skills, traits, and demographics of the applicants into a vector skill space such that similar skills can still influence selecting an applicant S150. For example, for the front-end Python software engineer position, an applicant may benefit from proficiency in some other programming language (e.g. Java); although not as much as an applicant proficient in Python. In the variation where all individuals within the human resource data are considered candidates for selecting the applicant S150, performing a multi-dimensional comparison S152, is performed on all individuals in the human resource data to determine a qualifying candidate(s) for selection (e.g., the most suitable candidate(s).

Performing a multi-dimensional comparison S152 may additionally take into account the bias report and/or additional preferred parameters. In one example, wherein the bias report shows a negative bias for promoting women into managerial positions at a company, the multi-dimensional comparison may introduce a preferred demographic parameter for women when determining the best applicant.

Block S160, which includes generating a report, functions in generating a report that includes the current, and past, state of the human resource data and any and/or all analyses pertaining to the human resource data and any and/or all data and analyses pertaining to already made and/or potential human resource decisions.

Generating a report S160 may include presenting the report. Presenting the report may preferably occur on an interactive dashboard. The interactive dashboard can be presented through a web application, a native application, and/or in any suitable format. Alternatively, presenting the data may comprise of presenting the data in a text report, non-interactive dashboard, through an API or using some other implementation. For the interactive dashboard, a user preferably chooses a preferred subset of information. The report and dashboard may include flags for certain warning points. For example, a preferred report may generate work life-cycle profile analyses for a specific hiring decision., Trends could be flagged for the overall process, a particular stage, a particular interviewer, job role, region, and the like may be shown, as shown in FIGS. 2A-2C.

Presenting on an interactive dashboard may additionally allow external input to add, change, ore remove parameters for human resource decisions and/or for determining bias. In some variations, the method through the dashboard may involve integrating with a recruitment system. The method may include automatically adjusting recruitment as the level of employment changes. Integrating with recruitment may include automatically selecting or biasing selection of applicants to counteract undesired demographic trends. In some cases, this can include generating and providing algorithmic guidance to humans when evaluating applicants.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for operating an inclusive human resource management tool comprising:
collecting human resource data from a set of individuals and public source data;
extracting demographic profile data from the human resource data for each individual from the set of individuals;
compiling the demographic profile data for the set of individuals into demographic rendering as part of the human resource data;
analyzing the human resource data, wherein analyzing the human resource data includes creating a bias report;
generating a report on the analyzed human resource data.

2. The method of claim 1, wherein collecting the human resource data from the set of individuals includes receiving the data from the set of individuals.

3. The method of claim 1, wherein public source data is comprised of accessible demographic data and data related to any subset of the set of individuals.

4. The method of claim 3, wherein collecting the human resource data from public source data comprises of searching and accessing accessible resources and websites.

5. The method of claim 3, wherein collecting the human resource data from public source data further comprises web scraping the public source data.

6. The method of claim 1, wherein demographic data includes gender classifications, race classifications, and age classifications.

7. The method of claim 1, further comprises selecting an applicant for a work life-cycle human resource decision.

8. The method of claim 7, wherein selecting an applicant comprises of performing a multi-dimensional comparison of candidates with respect to the work life-cycle human resource decision.

9. The method of claim 8, wherein selecting an applicant comprises of selecting the applicant satisfying a multi-dimensional comparison from the set of individuals.

10. The method of claim 8, wherein selecting an applicant comprises of selecting the applicant with the most suitable multi-dimensional comparison from the pool of all individuals stored in the human resource data.

11. The method of claim 7, wherein the work life-cycle human resource decision is a hiring process decision including: hiring, interview stage selection, or offer.

12. The method of claim 7, wherein the work life-cycle human resource decision is an employee related decision including: firing, promoting, demoting, transferring, rewarding, punishing, changing pay scale, designating a title, or removing title designation.

13. The method of claim 1, wherein extracting demographic profile data for each individual from the set of individuals comprises of copying explicit demographic data from the individual data of each individual and from the individual related data of each individual in the public source data.

14. The method of claim 13, wherein extracting demographic profile data for each individual from the set of individuals comprises of implicitly determining demographic data for each individual from non-demographic individual data and non-demographic individual related data.

15. The method of claim 14, wherein non-demographic individual data and non-demographic individual includes: name of individual, prior employment, location of birth, location of residence, and group affiliations.

16. The method of claim 1, wherein extracting demographic profile data comprises retrieving images of the individuals and applying image analysis to retrieve demographic data.

17. The method of claim 1, wherein generating a bias report comprises of determining and measuring a set of demographic biases with respect to human resource decision making.

18. The method of claim 17, wherein the set of demographic biases includes a gender bias metric and a racial bias metric.

19. A system for human resource management comprised of:
a tracking system integration, wherein the tracking system integration accesses, changes, and updates a work life-cycle profile for individuals;
a public data integration, wherein the public data integration accesses and incorporates public demographic data into the system;
a human resource profiling engine, wherein the human resource profiling engine combines individual work life-cycle data and the public demographic data and performs demographic analyses on the data; and
a dashboard configured to present.
